(19) United States
(12) Patent Application Publication
(10) Pub. No.: US 2022/0063746 A1
(43) Pub. Date: Mar. 3, 2022

(54) MOBILE DEVICE HOLDER FOR MOBILITY

(71) Applicants: Hyundai Motor Company, Seoul (KR); Kia Motors Corporation, Seoul (KR)

(72) Inventor: Hyun SONG, Hwaseong-si (KR)

(73) Assignees: Hyundai Motor Company, Seoul (KR); Kia Motors Corporation, Seoul (KR)

(21) Appl. No.: 17/182,970

(22) Filed: Feb. 23, 2021

(30) Foreign Application Priority Data
Aug. 31, 2020 (KR) 10-2020-0110012

(51) Int. Cl. B62J 9/30; B62J 9/21; B62J 11/00

(52) U.S. Cl. CPC B62J 9/30; B62J 11/00; B62J 9/21

(57) ABSTRACT

A mobile device holder for a mobility may include a body being able to be coupled to or separated from an upper end portion of the mobility and configured to provide information to a passenger of the mobility through a display disposed on a top of the body; and a clamp disposed at a side of the body and configured for holding a mobile device in a converted state when converting, such as protruding or unfolding, from the body.

### CROSS REFERENCE TO RELATED APPLICATION

The present application claims priority to Korean Patent Application No. 10-2020-0110012, filed Aug. 31, 2020, the entire contents of which is incorporated herein for all purposes by this reference.

### BACKGROUND OF THE INVENTION

### Field of the Invention

The present invention relates to a mobile device holder for a mobility, wherein the mobile device holder may be coupled to the upper end portion of a micro-mobility to provide information to passengers through a display or hold a mobile device, or may be separated from the micro-mobility and coupled to another side of the micro-mobility to serve as a support for supporting the mobility.

### Description of Related Art

Recently, as micro-mobilities such as an electric scooter are popularized and widely used, it is required to develop a holder that can hold a mobile device during the use of a micro-mobility. However, unlike the existing mobile device holders that are used for mobilities such as a vehicle or a bicycle, the entire sizes of micro-mobilities are small and are thus sensitive to vibration or shock. Therefore, where to mount a mobile device holder without deteriorating the external appearance of a micro-mobility is an important issue.

Accordingly, it is required to develop a mobile device holder for a mobility, which enables a passenger using a micro-mobility to easily couple the mobile device to the mobility, and can prevent the mobile device from being separated due to vibration or shock.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a mobile device holder for a mobility, which can be disposed at the upper end portion of a micro-mobility, includes a display disposed at the upper end portion thereof to provide a passenger with the state information of the micro-mobility through the display, and includes a clamp, the size of which is adjustable according to the size of a mobile device to hold the mobile device.

In order to solve the above technical problems, a mobile device holder for a mobility according to various exemplary embodiments of the present invention includes: a body detachably coupled to the upper end portion of a mobility and providing information to a passenger of the mobility through a display disposed on the top portion thereof; and a clamp disposed at a side of the body and configured for holding a mobile device in a converted state when converting, such as protruding or unfolding, from the body.

When the mobile device is disposed inside the clamp, the mobile device may be supported and held inside the clamp or on a top portion of the display.

The body may include an upper module and a lower module; the upper module may be selectively unfolded from the lower module and a mobile device can be held on a separation surface; and the lower module may be coupled to or separated from an upper end portion of the mobility.

The clamp may be disposed on a side of the upper module and a lower support which is selectively slid may be disposed on a side of the lower module.

When the upper module is unfolded from the lower module, a mobile device may be supported and held by both a separation surface of the upper module and a separation surface of a lower module.

When the upper module is unfolded from the lower module, a mobile device may be disposed inside both of the clamp and the lower support.

When the upper module is folded over or unfolded from the lower module, the lower support may protrude and carry a load.

When the upper module is unfolded from the lower module, a holding angle of a mobile device may be adjusted in accordance with an unfolding angle of the upper module.

When the upper module is unfolded from the lower module, a holding angle of a mobile device may be adjusted in accordance with angles of separation surfaces of the upper module and the lower module.

An anti-sliding portion may be formed on a portion that comes in contact with a mobile device of the clamp or the body.

When the upper module is unfolded from the lower module and a mobile device is held on a separation surface, an anti-sliding portion may be formed on a portion that comes in contact with the mobile device.

A battery may be disposed in the body, a mobile device may be charged by the battery in the body when the mobile device is disposed on the body, and the battery may be charged with the body separated from the mobility.

The body may function as a support that supports the mobility when the body is separated from the upper end portion of the mobility and coupled to another portion of the mobility.

A locking device may be disposed on a side of the body and may fix the mobility to an external device with the body coupled to a portion of the mobility.

The mobility may be a scooter and the body may be disposed on an upper end portion of the scooter.

According to the mobile device holder for a mobility of the present invention, the holder is coupled to the upper end portion of a micro-mobility and a display is disposed on the top portion of the holder, to provide the state information of the micro-mobility to a passenger. Furthermore, the holder includes a clamp, the size of which is adjustable according to the size of a mobile device to hold the mobile device. Moreover, the mobile device holder may be separated from the upper end portion of a mobility and then coupled to another side of the mobility to serve as a support for supporting the mobility.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the state in which a mobile device holder for a mobility according to various exemplary embodiments of the present invention is coupled to the upper end portion of a mobility;

FIG. 2 is a view showing the state in which a mobile device can be disposed with a clamp of the mobile device holder for a mobility according to various exemplary embodiments of the present invention protruded;

FIG. 3 is a view showing the state in which a mobile device can be disposed with an upper module of the mobile device holder for a mobility according to various exemplary embodiments of the present invention unfolded;

FIG. 4 is a side view showing the state in which a mobile device has been disposed with the upper module of the mobile device holder for a mobility according to various exemplary embodiments of the present invention unfolded;

FIG. 5 is a view in which the mobile device holder for a mobility according to various exemplary embodiments of the present invention has been separated from the upper end portion of a mobility and is used as a mobility support at the lower end portion of the mobility;

FIG. 6 is a view showing the state in which a mobile device can be disposed with the upper module of the mobile device holder for a mobility according to various exemplary embodiments of the present invention unfolded and slid upwards;

FIG. 7 is a view showing the state in which a mobile device can be disposed with the upper module of the mobile device holder for a mobility according to various exemplary embodiments of the present invention unfolded and protruded forward;

FIG. 8 is a view showing the state in which a mobile device can be disposed with a lower support on the rear surface of the upper module of the mobile device holder for a mobility according to various exemplary embodiments of the present invention unfolded;

FIG. 9 is a view showing the state in which a mobile device can be disposed with an upper support on the front surface of the upper module of the mobile device holder for a mobility according to various exemplary embodiments of the present invention unfolded;

FIG. 10 is a view showing the state in which a mobile device can be disposed with the upper module of the mobile device holder for a mobility according to various exemplary embodiments of the present invention slid upwards;

FIG. 11 is a view showing the state in which a mobile device can be disposed with the clamp of the mobile device holder for a mobility according to various exemplary embodiments of the present invention unfolded forward and rearward thereof;

FIG. 12 is a view showing the state in which a mobile device can be disposed with the clamp of the mobile device holder for a mobility according to various exemplary embodiments of the present invention unfolded to both sides;

FIG. 13 is a view showing the state in which a mobile device can be disposed with the clamp unfolded from the front surface of the upper module of the mobile device holder for a mobility according to various exemplary embodiments of the present invention; and

FIG. 14 is a view showing the state in which a mobile device can be disposed with the clamp slid, protruded forward, and unfolded from the front surface of the upper module of the mobile device holder for a mobility according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

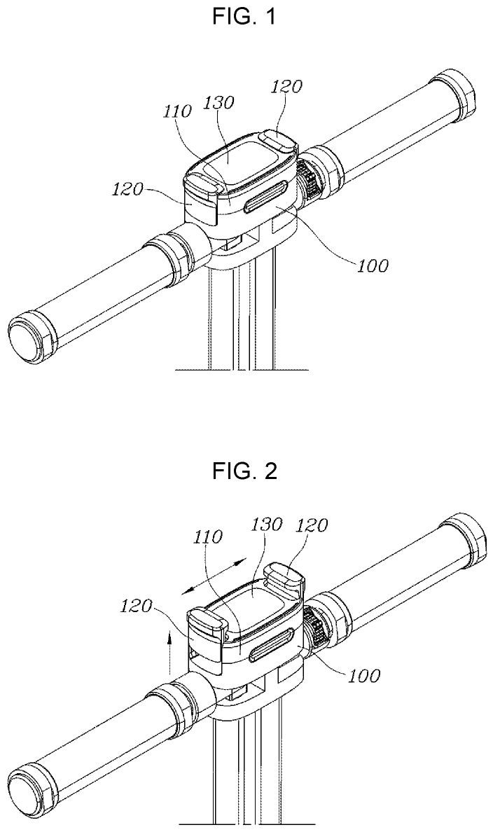

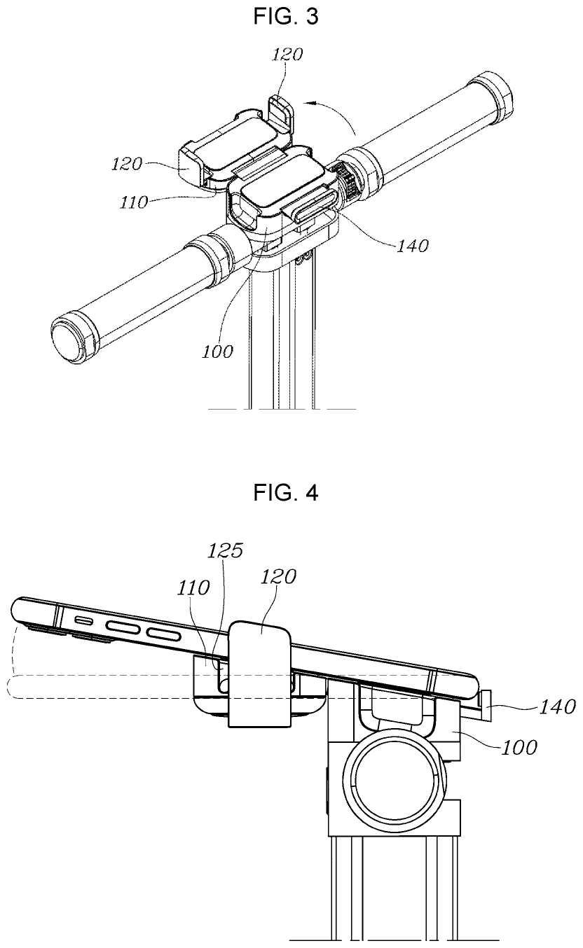

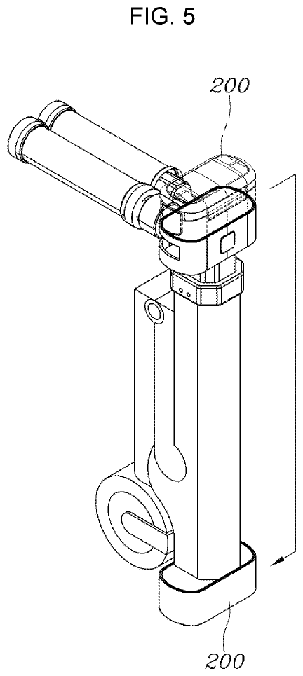

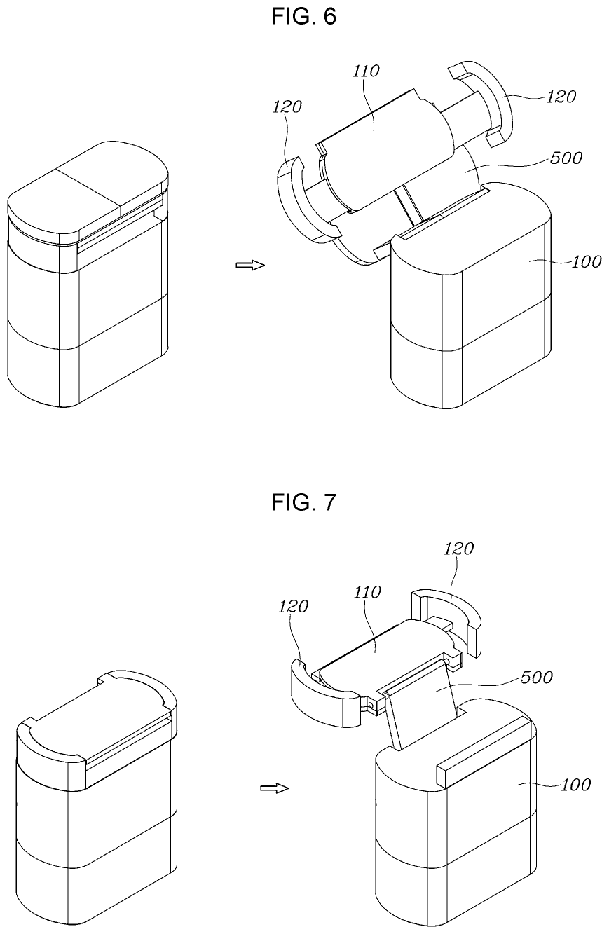

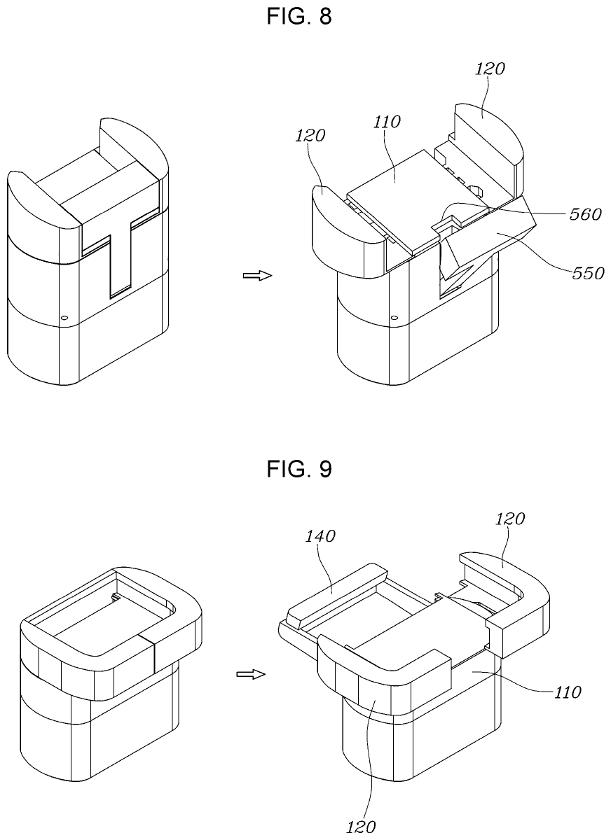

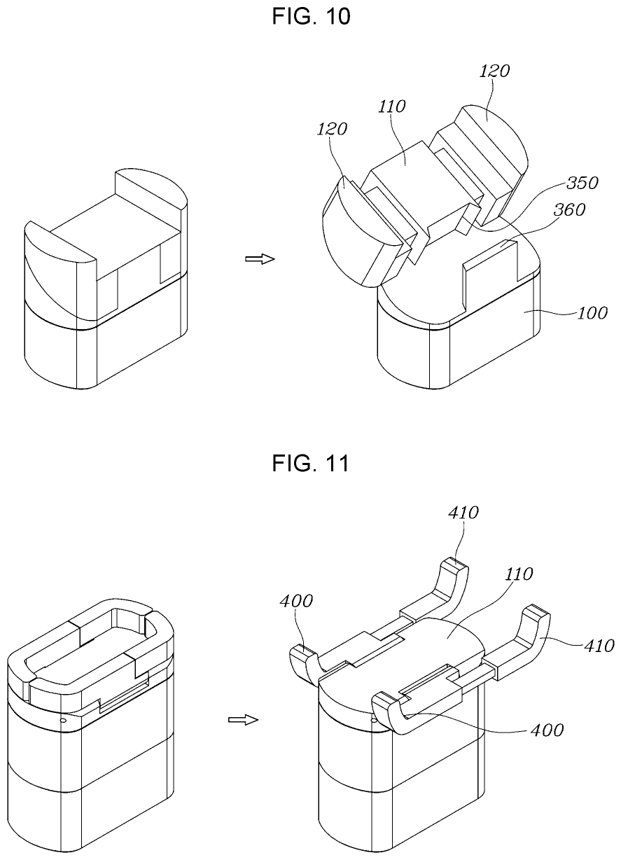

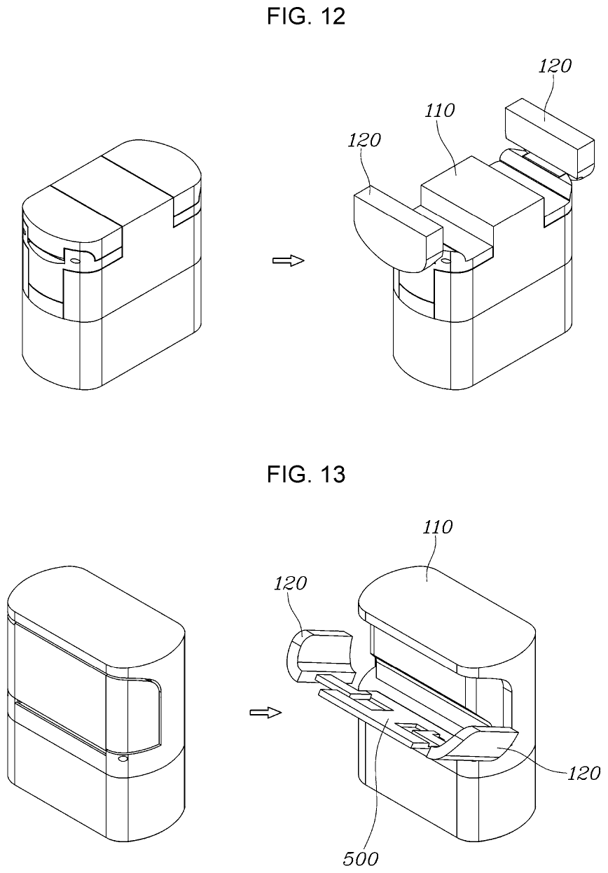

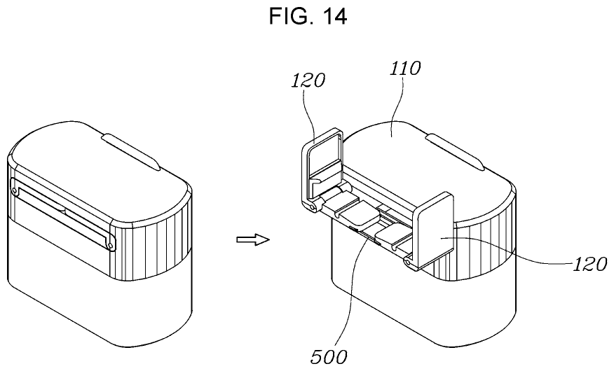

FIG. 1 is a view showing the state in which a mobile device holder for a mobility according to various exemplary embodiments of the present invention is coupled to the upper end portion of a mobility. FIG. 2 is a view showing the state in which a mobile device can be mounted with a clamp of the mobile device holder for a mobility according to various exemplary embodiments of the present invention protruded. FIG. 3 is a view showing the state in which a mobile device can be mounted with an upper module of the mobile device holder for a mobility according to various exemplary embodiments of the present invention unfolded. FIG. 4 is a side view showing the state in which a mobile device has been mounted with the upper module of the mobile device holder for a mobility according to various exemplary embodiments of the present invention unfolded. FIG. 5 is a view in which the mobile device holder for a mobility according to various exemplary embodiments of the present invention has been separated from the upper end portion of a mobility and is used as a mobility support at the lower end portion of the mobility. FIG. 6 is a view showing the state in which a mobile device can be mounted with the upper module of the mobile device holder for a mobility according to various exemplary embodiments of the present invention unfolded and slid upwards. FIG. 7 is a view showing the state in which a mobile device can be mounted with the upper module of the mobile device holder for a mobility according to various exemplary embodiments of the present invention unfolded and protruded forward thereof. FIG. 8 is a view showing the state in which a mobile device can be mounted with a lower support on the rear surface of the upper module of the mobile device holder for a mobility according to various exemplary embodiments of the present invention unfolded. FIG. 9 is a view showing the state in which a mobile device can be mounted with an upper support on the front surface of the upper module of the mobile device holder for a mobility according to various exemplary embodiments of the present invention unfolded. FIG. 10 is a view showing the state in which a mobile device can be mounted with the upper module of the mobile device holder for a mobility according to various exemplary embodiments of the present invention slid upwards. FIG. 11 is a view showing the state in which a mobile device can be mounted with the clamp of the mobile device holder for a mobility according to various exemplary embodiments of the present invention unfolded forward and rearward thereof. FIG. 12 is a view showing the state in which a mobile device can be mounted with the clamp of the mobile device holder for a mobility according to various exemplary embodiments of the present invention unfolded to both sides. FIG. 13 is a view showing the state in which a mobile device can be mounted with the clamp unfolded from the front surface of the upper module of the mobile device holder for a mobility according to various exemplary embodiments of the present invention. FIG. 14 is a view showing the state in which a mobile device can be mounted with the clamp slid, protruded forward, and unfolded from the front surface of the upper module of the mobile device holder for a mobility according to various exemplary embodiments of the present invention.

FIG. 1 is a view showing the state in which a mobile device holder for a mobility according to various exemplary embodiments of the present invention is coupled to the upper end portion of a mobility. FIG. 5 is a view in which the mobile device holder for a mobility according to various exemplary embodiments of the present invention has been separated from the upper end portion of a mobility and is used as a mobility support at the lower end portion of the mobility. A mobile device holder for a mobility according to various exemplary embodiments of the present invention includes: a body 200 being able to be coupled to or separated from the upper end portion of a mobility and providing information to a passenger of the mobility through a display 130 mounted on the top portion thereof; and a clamp 120 mounted at a side of the body and configured for holding a mobile device in a converted state when converting, such as protruding or unfolding, from the body 200.

The mobility stated herein is a compact vehicle and means a micro-mobility such as an electric scooter, a motor scooter, a hoverboard, and an electric unicycle. In the mobile device holder for a mobility according to various exemplary embodiments of the present invention, the mobility may be a scooter and the body 200 may be disposed at the upper end portion of the scooter. A scooter usually has two wheels at the front and the rear, a board between the wheels, a column over the front wheel, and a handle at the upper end portion of the column. According to the mobile device holder for a mobility according to various exemplary embodiments of the present invention, in such a fundamental scooter structure, a display or a mobile device holder is disposed at the upper end portion of the scooter so that a rider can drive while easily looking at a display or a mobile device.

In detail, in the mobile device holder for a mobility according to various exemplary embodiments of the present invention, the body 200 can be attached to or detached from the mobility and the display 130 is disposed on the top portion of the body 200. The state of the scooter such as a speed and a mileage is disposed on the display 130, so a rider can be simply provided with information. A clamp 120 is disposed on a side of the body 200. The clamp 120 is used to hold a mobile device such as in a way that it is stowed in the body 200 and is then protruded or unfolded when it is used and in a way that it is protruded or unfolded from the body 200 and the width is adjusted in accordance with the size of a mobile device.

In the mobile device holder for a mobility according to various exemplary embodiments of the present invention, the body 200 has a built-in battery, and when a mobile device is disposed on the body 200, the mobile device can be charged by the battery of the body 200. The battery can be charged with the body 200 separated from the mobility. In other words, the body 200 functions as an external battery, and when a mobile device is disposed, it is possible to charge the mobile device in a wire or wireless type and maintain the power of the mobile device.

In the mobile device holder for a mobility according to various exemplary embodiments of the present invention, a locking device is disposed on a side of the main body 200 and can fix the mobility to an external device with the body 200 coupled to a side of the mobility. A micro-mobility such as a scooter is small, so it may be vulnerable to theft. Accordingly, the mobile device holder for a mobility according to various exemplary embodiments of the present invention has a locking device such as a lock on a side of the body 200, so it is possible to prevent robbery of a mobility in various ways such as by fastening the locking device to another external device with the holder coupled to the mobility.

In the mobile device holder for a mobility according to various exemplary embodiments of the present invention, when the body 200 is separated from the upper end portion of the mobility and coupled to another portion of the mobility, the body 200 is configured as a support that supports the mobility. Since scooters usually have a wheel at each of the front and the rear, there is a defect that a user has to lean a scooter on an external device or lay a scooter in order to place it. Accordingly, by separating the mobile device holder for a mobility according to various exemplary embodiments of the present invention from the upper end portion and coupling it to another portion of a mobility, it is possible to more stably place or keep the mobility by use of the mobile device holder for a mobility as a mobility holder. In detail, when the mobile device holder for a mobility at the center portion of the handle at the upper end portion of a mobility is separated, the mobility is folded to minimize the volume, and then the mobile device holder for a mobility is coupled to the lower end portion of the folded mobility such that a stable portion is supported on the ground, it is possible to more stably place or keep the mobility in comparison to placing only the mobility. When the mobile device holder for a mobility is used as a support, the holder may more stably function as a mobility holder if an additional support is protruded from the mobile device holder for a mobility or a fixing portion that can be securely fixed to an external device is additionally provided.

FIG. 2 is a view showing the state in which a mobile device can be mounted with a clamp of the mobile device holder for a mobility according to various exemplary embodiments of the present invention protruded. In the mobile device holder for a mobility according to various exemplary embodiments of the present invention, when the mobile device is mounted inside the clamp 120, the mobile device can be supported inside the clamp 120 or on the top portion of the display 130. In detail, when a mobile device is mounted on the mobile device holder for a mobility according to various exemplary embodiments of the present invention, simply, a clamp 120 has two claws protruding at the sides and a mobile device can be mounted by adjusting the width of the clamp 120. Alternatively, when a clamp 120 has a specific holding surface, it is possible to protrude or unfold the clamp 120 from the body 200 and then mount a mobile device on the holding surface of the clamp 120.

Furthermore, it is possible to mount a mobile device on the top portion of the display 130 using the top portion as a holding surface and then hold the mobile device using the clamp 120. In the instant case, the mobile device can be securely fixed, so it is possible to prevent the mobile device from separating from the mobility due to vibration or shock. However, when the top portion of the display 130 is used as a holding surface for a mobile device, there is a defect the mobile device covers the screen of the display 130; nevertheless, the rider may be provided with more various and accurate information than the information provided from the display 130 through the mobile device. Accordingly, the defect can be overcome by the disposed mobile device.

Accordingly, when a rider does not know a route well or moves a complicated route, it is preferable for the rider to mount a mobile device and receive information such as the route and traffic situation through the mobile device rather than the display 130.

Alternatively, when a rider knows a route well or wants to receive only the state information of the scooter, the rider may receive information through the display 130 without mounting a mobile device. Alternatively, when the clamp 120 has a specific holding surface and a mobile device is disposed on the holding surface without using the top portion of the display 130 as a holding surface for a mobile device, a rider can be provided information from both of the mobile device and the display 130.

In the mobile device holder for a mobility according to various exemplary embodiments of the present invention, an anti-sliding portion may be formed on the portion the clamp 120 or the body 200 with which a mobile device comes in contact. The anti-sliding portion may be provided on the portion with which a mobile device comes in contact or a supporting surface that supports a mobile device in the clamp 120 or may be provided on the top portion or the supporting surface of the display 130 that supports a mobile device in the body 200. Accordingly, the fixing force when a mobile device is disposed on the holder is increased, whereby it is possible to prevent the mobile device from separating from the holder.

In an exemplary embodiment of the present invention, the upper module 110 includes a sliding hole 125 to receive an end portion of the clamp 120 such that the clamp 120 can slide along the longitudinal direction of the upper module 110.

In an exemplary embodiment of the present invention, the diameter of the sliding hole 125 is sufficiently large enough for the clamp 120 to move in a height direction of the upper module 110, as shown in FIG. 2.

FIG. 3 is a view showing the state in which a mobile device can be disposed with an upper module of the mobile device holder for a mobility according to various exemplary embodiments of the present invention unfolded. In the mobile device holder for a mobility according to various exemplary embodiments of the present invention, the body 200 includes an upper module 110 and a lower module 100. The upper module 110 is selectively unfolded from the lower module and a mobile device can be held on the separation surface. The lower module 100 can be coupled to or separated from the upper end portion of the mobility.

In the mobile device holder for a mobility according to various exemplary embodiments of the present invention, the upper module 110 is unfolded from the lower module 100 and a mobile device is held on the separation surface, whereby it is possible to hold a mobile device in a larger area. Accordingly, it is possible to more stably hold a mobile device in comparison to mounting a mobile device using only the clamp 120 or mounting a mobile device using the top portion of the display 130 as a holding surface. The lower module 100, similar to the body 200 described above, can be coupled to or separated from the upper end portion of a mobility. Accordingly, the lower module 100 may be separated from a mobility and used for charging the battery disposed in the body or may be coupled to a side of a mobility and used as a support that supports the mobility.

In the mobile device holder for a mobility according to various exemplary embodiments of the present invention, the clamp 120 may be disposed on a side of the upper module 110 and a lower support 140 that selectively slides into the lower module 110 may be disposed on a side of the lower module 100. After the upper module 110 is unfolded from the lower module 100, the clamp 120 protrudes from the upper module 110 and then a mobile device is disposed on the clamp 120. Thereafter, the lower support 140 disposed on a side of the lower module 100 may slide to fit to the size of the mobile device.

In the mobile device holder for a mobility according to various exemplary embodiments of the present invention, when the upper module 110 is folded over or unfolded from the lower module 100, the lower support 140 may protrude and carry a load. In general, when using a scooter, both hands are positioned on the handle, but if there is a load to carry, it may be impossible to use a scooter. Accordingly, even though a mobile device is held on the mobile device holder for a mobility or not, it is possible to hook and carry a load on the lower support 140 when using a scooter by use of the lower support 140 as a fixing hook.

In the mobile device holder for a mobility according to various exemplary embodiments of the present invention, when the upper module 110 is unfolded from the lower module 100 and a mobile device is held on the separation surface, an anti-sliding portion may be formed on the portion which is in contact with the mobile device. Similarly, the anti-sliding portion may be disposed on the supporting surface that supports a mobile device of the clamp 120, the upper module 110, or the lower module 100. Accordingly, when a mobile device is disposed on the holder, the mobile device is more securely fixed, so it is possible to prevent the mobile device from separating from the holder.

In an exemplary embodiment of the present invention, a pivotal member 500 is disposed between the upper module 110 and the lower module 100 to pivotally connect the upper module 110 and the lower module 100.

FIG. 4 is a side view showing the state in which a mobile device has been disposed with the upper module of the mobile device holder for a mobility according to various exemplary embodiments of the present invention unfolded. In the mobile device holder for a mobility according to various exemplary embodiments of the present invention, when the upper module 110 is unfolded from the lower module 100, the mobile device may be supported and held on both of the separation surface of the upper module 110 and the separation surface of the lower module 100. When a mobile device is supported on two separation surfaces after the upper module 110 is unfolded, the supporting area is greater than that when a mobile device is supported inside the clamp 120 not unfolded yet or on the top portion of the display 130, so that the mobile device can be more stably held on the holder and the possibility of separation from the holder decreases.

In the mobile device holder for a mobility according to various exemplary embodiments of the present invention, when the upper module 110 is unfolded from the lower module 100, the mobile device may be disposed on both of the clamp 120 and the lower support 140. In the instant case, the lower support 140 not only is configured to prevent the mobile device from separating downward, but also is configured to supplement the fixing force for mounting the mobile device, so that the fixing force increases in comparison to mounting the mobile device only with the clamp 120. Accordingly, it is possible to prevent the mobile device from separating from the mobile device holder for a mobility due to vibration or shock and it is also possible to more stably hold the mobile device on the mobile device holder for a mobility.

In the mobile device holder for a mobility according to various exemplary embodiments of the present invention, when the upper module 110 is unfolded from the lower module 100, the holding angle of a mobile device may be adjusted in accordance with the unfolding angle of the upper module 110. Furthermore, when the upper module 110 is unfolded from the lower module 100, the holding angle of a mobile device may be adjusted in accordance with the angles of the separation surfaces of the upper module 110 and the lower module 100.

In detail, when the upper module 110 is unfolded from the lower module 100 and then a mobile device is disposed inside the clamp 120 of the upper module 110 with the lower end portion thereof supported by the lower module 100, the holding angle of the mobile device depends on the unfolding angle of the upper module 110. When the upper module 110 is unfolded from the lower module 100 and then a mobile device is supported on both of the separation surface of the upper module 110 and the separation surface of the lower module 100, the holding angle of the mobile device depends on the angles of the separation surfaces of the upper module 110 and the lower module 100. Therefore, when using a mobility, a passenger can hold a mobility at an optimal angle or change the holding angle in accordance with the physical condition and the height of the eyes of the passenger and the external environment such as reflection of sunlight.

FIG. 6 is a view showing the state in which a mobile device can be disposed with the upper module of the mobile device holder for a mobility according to various exemplary embodiments of the present invention unfolded and slid upwards. In an exemplary embodiment of the present invention, a pivotal member 500 is pivotally mounted between the lower module 100 and the upper module 110 and the upper module 110 is slidably mounted to the upper module 110.

FIG. 7 is a view showing the state in which a mobile device can be disposed with the upper module of the mobile device holder for a mobility according to various exemplary embodiments of the present invention unfolded and protruded forward thereof. In an exemplary embodiment of the present invention, a pivotal member 500 is pivotally mounted between the lower module 100 and the upper module 110 and the upper module 110 is pivotally mounted to the upper module 110.

According to the mobile device holder for a mobility according to various exemplary embodiments of the present invention, as shown in FIG. 6 and FIG. 7, the upper module may be unfolded and slid up or may be unfolded and protrude forward with the clamp stowed, whereby a supporting surface for a mobile device is formed and the mobile device can be held thereon.

FIG. 8 is a view showing the state in which a mobile device can be disposed with a lower support on the rear surface of the upper module of the mobile device holder for a mobility according to various exemplary embodiments of the present invention unfolded. A locking bar 550 is hingedly coupled to the lower module 100 and selectively disposed between the clamps 120 to be engaged into a locking groove 560 of the upper module 110.

FIG. 9 is a view showing the state in which a mobile device can be disposed with an upper support on the front surface of the upper module of the mobile device holder for a mobility according to various exemplary embodiments of the present invention unfolded. FIG. 10 is a view showing the state in which a mobile device can be disposed with the upper module of the mobile device holder for a mobility according to various exemplary embodiments of the present invention slid upwards. According to the mobile device holder for a mobility according to various exemplary embodiments of the present invention, an upper support or a lower support may be unfolded with the clamp exposed or protruded outside and then the upper module may be slid up, and in the instant state, a mobile device can be held.

In an exemplary embodiment of the present invention in FIG. 10, the upper module 110 includes a locking groove 350 and the lower module 100 includes a locking protrusion 360 so that the lower module 100 and the upper module 110 are selectively coupled to each other when the upper module 110 slides on the lower module 100.

FIG. 11 is a view showing the state in which a mobile device can be disposed with the clamp of the mobile device holder for a mobility according to various exemplary embodiments of the present invention unfolded forward and rearward thereof. The clamp of the mobile device holder includes a fixed clamp 400 hingedly connected to the body 200 and a sliding clamp 410 slidably engaged to the fixed clamp such that the sliding clamp is slidably with respect to the fixed clamp

FIG. 12 is a view showing the state in which a mobile device can be disposed with the clamp of the mobile device holder for a mobility according to various exemplary embodiments of the present invention unfolded to both sides. According to the mobile device holder for a mobility according to various exemplary embodiments of the present invention, the clamp which is exposed or protruded outside may be unfolded in the front-rear direction or laterally, and in the instant state, a mobile device can be held.

FIG. 13 is a view showing the state in which a mobile device can be disposed with the clamp unfolded from the front surface of the upper module of the mobile device holder for a mobility according to various exemplary embodiments of the present invention. In an exemplary embodiment of the present invention, a pivotal member 500 is pivotally mounted on a side of the upper module 110 and the clamps 120 are slidably mounted on the pivotal member 500.

FIG. 14 is a view showing the state in which a mobile device can be disposed with the clamp slid, protruded forward, and unfolded from the front surface of the upper module of the mobile device holder for a mobility according to various exemplary embodiments of the present invention. In an exemplary embodiment of the present invention, a pivotal member 500 is slidably mounted on a side of the upper module 110 and the clamps 120 are pivotally mounted on the pivotal member 500.

According to the mobile device holder for a mobility according to various exemplary embodiments of the present invention, the clamp which is stowed in the upper module or a lower module may be unfolded from the front of the upper module or slide out from the front of the upper module and then a side clamp may be unfolded to form a holding surface for a mobile device, and in the instant state, a mobile device can be held.

Referring to FIGS. 6 to 13, there are differences and effects such as whether the clamp is stowed not to be seen from the outside, whether it is possible to secure a larger supporting surface or adjust the angle of the holder by unfolding the upper module, and whether it is possible to support a mobile device in a plurality of directions. Therefore, a user may select and use various embodiments, depending on his or her taste or necessity.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described in order to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A mobile device holder for a mobility, the mobile device holder comprising:
a body configured to be coupled to or separated from an upper end portion of the mobility and to provide information to a passenger of the mobility through a display disposed on a top of the body; and
a clamp mounted at a side of the body and configured for selectively holding a mobile device.

2. The mobile device holder of claim 1, wherein when the mobile device is disposed inside the clamp, the mobile device is supported and held inside the clamp or on a top portion of the display.

3. The mobile device holder of claim 1,
wherein the body includes an upper module and a lower module,
wherein the upper module is selectively unfolded from the lower module and the mobile device is configured to be held on a separation surface of either of the upper module and the lower module, and
wherein the lower module is configured to be coupled to or separated from an upper end portion of the mobility.

4. The mobile device holder of claim 3, wherein the clamp is disposed on a side of the upper module and a lower support which is selectively slid is slidably mounted in a side of the lower module.

5. The mobile device holder of claim 3, wherein when the upper module is unfolded from the lower module, the mobile device is supported and held by the separation surface of the upper module and the separation surface of the lower module.

6. The mobile device holder of claim 4, wherein when the upper module is unfolded from the lower module, the mobile device is disposed inside the clamp and the lower support.

7. The mobile device holder of claim 4, wherein when the upper module is folded over or unfolded from the lower module, the lower support protrudes and is configured to carry a load.

8. The mobile device holder of claim 3, wherein when the upper module is unfolded from the lower module, a holding angle of the mobile device is adjusted in accordance with an unfolding angle of the upper module.

9. The mobile device holder of claim 3, wherein when the upper module is unfolded from the lower module, a holding angle of the mobile device is adjusted in accordance with angles of the separation surfaces of the upper module and the lower module.

10. The mobile device holder of claim 1, wherein an anti-sliding portion is formed on a portion that comes in contact with the mobile device of the clamp or the body.

11. The mobile device holder of claim 3, wherein when the upper module is unfolded from the lower module and the mobile device is held on the separation surface, an anti-sliding portion is formed on a portion that comes in contact with the mobile device.

12. The mobile device holder of claim 1, wherein a battery is disposed in the body, the mobile device is charged by the battery in the body when the mobile device is disposed on the body, and the battery is configured to be charged with the body separated from the mobility.

13. The mobile device holder of claim 1, wherein the body works as a support that supports the mobility when the body is separated from the upper end portion of the mobility and coupled to another portion of the mobility.

14. The mobile device holder of claim 1, wherein a locking device is disposed on a side of the body and fixes the mobility to an external device with the body coupled to a portion of the mobility.

15. The mobile device holder of claim 1, wherein the mobility is a scooter and the body is disposed on an upper end portion of the scooter.

16. The mobile device holder of claim 1, further including a pivotal member,
wherein the body includes an upper module and a lower module,
wherein an end of the pivotal member is pivotally connected to the lower module, and
wherein the upper module is slidably coupled to another end of the pivotal member.

17. The mobile device holder of claim 1, further including a pivotal member,
wherein the body includes an upper module and a lower module,
wherein an end of the pivotal member is pivotally connected to the lower module, and
wherein the upper module is pivotally coupled to another end of the pivotal member.

18. The mobile device holder of claim 1,
wherein the body includes an upper module and a lower module, and
wherein a locking bar is hingedly coupled to the lower module or a locking protrusion is formed to extend from a portion of the lower module, and configured to be selectively engaged into a locking groove of the upper module.

19. The mobile device holder of claim 1, wherein the clamp of the mobile device holder includes a fixed clamp hingedly connected to the body and a sliding clamp slidably engaged to the fixed clamp so that the sliding clamp is slidably with respect to the fixed clamp.

20. The mobile device holder of claim 1,
wherein the body includes an upper module and a lower module,
wherein a pivotal member is pivotally or slidably mounted on a side of the upper module, and
wherein the clamp is slidably or pivotally mounted on the pivotal member.
